(19) United States
(12) Patent Application Publication
(10) Pub. No.: US 2007/0142506 A1
(43) Pub. Date: Jun. 21, 2007

(54) Additive used for treating clay/salt in situ materials in order to turn them into aggregates for cement mortar and cement concrete

(76) Inventors: Nguyen Hong Binh, Ho Chi Minh City (VN); Tran Ngoc Lam, Ho Chi Minh City (VN); Nguyen Hong Anh, Ho Chi Minh City (VN); Nguyen Hong Minh, Ho Chi Minh City (VN)

Correspondence Address: DONN K. HARMS;PATENT & TRADEMARK LAW CENTER, SUITE 100, 12702 VIA CORTINA, DEL MAR, CA, 92014, US

(21) Appl. No.: 11/635,259

(22) Filed: Dec. 6, 2006

(30) Foreign Application Priority Data
Dec. 19, 2005 (VN) 1-2005-01867

(51) Int. Cl. C04B 24/26

(52) U.S. Cl. 524/2

(57) ABSTRACT

The invention relates to an additive (named CSSB) generally comprising (by weight): 10% to 50% of polymer solution; 10% to 20% of alkyl benzene sulfonate; 5% to 10% of sodium carbonate or sodium phosphate; 2% to 10% of sulfuric acid and 10% to 73% of saltwater or salt-contaminated water. The CSSB additive is used for treating clay and salt in unsuitable in situ building materials, such as soil, soil containing clay, clay containing stone, clay containing sand, gravelly soil, saline-sand, and saline contaminated water in order to turn them into aggregates for cement mortar and cement concrete. The invention also relates to methods for making cement-mortar and cement-concrete by using such additive which incorporates such aggregates.

### FIELD OF THE INVENTION

This invention relates to an additive (named as CSSB) used for treating clay and salt in unsuitable in situ building materials, such as soil, soil containing clay, clay containing stone, clay containing sand, gravelly soil, saline-sand, saline contaminated water in order to turn them into aggregates. The invention also relates to methods for making cement mortar and cement concrete by using such additive which incorporate such aggregates.

### BACKGROUND OF THE INVENTION

Unsuitable in situ building materials such as soil, soil containing clay, clay containing stone, clay containing sand, gravelly soil, saline-sand, and saline contaminated water cannot be used for making concrete by traditional methods.

Cement-mortar and cement-concrete are a mixture of aggregates with a high-grade Portland cement being a common binder. The aggregates most commonly used in cement mortar and cement concrete are fresh sand (yellow sand or river-sand), fresh gravel or stone. High-grade Portland cement is a common binder. The aggregates and binder are mixed together with fresh water (soft water). Upon hydration the binder solidifies and binds the aggregates together into a solid mass.

A problem with the use of the unsuitable in situ building materials for aggregates in concrete and mortar compositions to build infrastructure projects is that most common binders, such as Portland cement, do not adhere well to them. The result is that concrete and mortar using in situ materials for aggregates is significantly weaker than ordinary concrete and mortar for several reasons.

Firstly, when soil containing clay, clay containing stone, clay containing sand, gravelly soil, saline-sand, and saline contaminated water were utilized in the concrete mix used to build structures in the South of Vietnam, for example, the high clay content of such alluvium caused extensive expansion within the concrete and mortar as well as cracking and spalling of the concrete when dry.

Secondly, NaCl in water will be separated into Na⁺ and Cl⁻, and FeO, MgO, AlO in Portland cement will be separated in the hydrating process of cement into cations Fe⁺⁺, Al⁺⁺⁺ and Mg⁺⁺. When mixing such aggregates with cement, cations Fe⁺⁺, Al⁺⁺⁺ and Mg⁺⁺ are attracted to ion Cl⁻, creating dissolving compounds such as iron chloride, aluminum chloride and magnesium chloride. Then these compounds are combined with water to obtain Fe(OH)₂, Al(OH)³, Mg(OH)₂ which are not durable, are spongy and expand many times. NaOH is created by combining Na⁺ with water so that when the in situ materials, such as soil, soil containing clay, clay containing stone, clay containing sand, gravelly soil, saline-sand, saline contaminated water, salt-sand and saltwater are utilized in the concrete mix used to build structures in South Vietnam, for example, upon the moisture changes, building products will expand or contract, causing cracks, decreasing force-resistance and stability of the construction.

The problem is to treat or improve the unsuitable in situ building materials, such as soil, soil containing clay, clay containing stone, salt-sand and saltwater in order to turn them into aggregates suitable for use in cement mortar and concrete in order to build infrastructures in regions of poor soil and saline contaminated land, thus decreasing the high cost of transporting high-quality building materials such as sand, stone, water from other places, and thereby reducing the time of completing construction.

As already known, various solutions have been proposed for making additives for building materials, such as additives for stabilizing the soil pavement and the road surface, and additives to improve protection against corrosion of reinforced steel concrete in regions of salt-contaminated soil and/or water, therefore increasing the solidity and durability of concrete. However, the inventor of the present application proposes preparing a kind of additive (novel additive) used for treating clay/salt in the unsuitable in situ building materials, such as soil, soil containing clay, clay containing stone, salt-sand and saltwater, in order to change the intrinsic behavior of these materials by preventing water-reabsorption and salt-reabsorption into such materials, therefore increasing the natural weight and pressure endurance of treated materials, thus allowing for the use of these treated materials as aggregates for making mortar and concrete compositions that are suitable for the building of infrastructure projects such as irrigation projects, traffic projects, civil projects, etc. in regions of poor or salt contaminated soil in an inexpensive and timely way.

The additive of this invention is created in a manner in which the additive for treating the clay/salt is a compound having a big electric-activity surface which absorbs the salt-electrolytic dissociation of saltwater, and eliminates the creation of metal hydroxides and NaOH in the hydrating process of cement in saltwater in order to create inert compounds which have not been expanded or contracted.

### SUMMARY OF THE INVENTION

A first object of the invention is to provide an additive (named as CSSB) used for treating clay and salt in unsuitable in situ building materials, such as soil, soil containing clay, clay containing stone, clay containing sand, gravelly soil, saline-sand, and saline-contaminated water. The CSSB additive according to the invention is a mixture of a polymer solution, salts of organic acids, salts of inorganic acids and catalyst.

A second object of the invention is to provide methods for making cement-mortar and cement-concrete by using such a CSSB additive which incorporates such treated aggregates.

The first object of the invention is created such that the CSSB additive is a compound having a large electric-activity surface which absorbs the salt-electrolytic dissociation of saltwater, and eliminates the creation of metal hydroxides and NaOH in the hydrating process of cement in saltwater in order to create inert compounds which do not expand or contract.

The second object of the invention is provided by the mixing process using the treated in situ materials as aggregates with the binder, such as Portland cement which is taken by an electro-physicochemical method under the environment of low pH. The action of the CSSB additive of the invention employs the strong electrochemistry of the main cations in soil containing salt, sand containing salt, stone containing stone, and saltwater, such as Na⁺, Ca⁺⁺, Mg⁺⁺, Fe⁺⁺ and the anions, such as Cl⁻, SO4⁻⁻ are combined into inert compounds. Furthermore, there is an ion-exchange in this process so that the remaining substances in soil containing salt, sand containing salt, stone containing salt and saltwater are precipitated.

### DETAILED DESCRIPTION OF THE INVENTION

An additive (named as CSSB) according to the present invention is a mixture comprising:

10% to 50% (by weight) polymer solution;

10% to 20% (by weight) salts of organic acids;

5% to 10% (by weight) salts of inorganic acids;

2% to 10% (by weight) catalyst;

10% to 73% (by weight) saltwater or salt-contaminated water.

The polymer solution used in the CSSB additive of the present invention may be, for example, a polymer styrene such as those available under the trade name of PS;

The salts of the organic acids used in the CSSB additive of the present invention may be, for example, alkyl benzene sulphonate solution, such as those available under the trade name of LABS;

The salts of the inorganic acids used in the CSSB additive of the present invention, may be, for example, sodium carbonate (Na₂CO₃) or sodium phosphate (Na₂PO₄);

The catalyst used in the present invention, may be, for example, sulfuric acid (H2SO4) or phosphoric acid (H₃PO₄);

The additive (named as CSSB) according to the present invention has the following physico-chemical characteristics:

Appearance: emulsion;

Color: opalescent;

Smell: specific pungent smell of acid;

pH ≦3;

Material Density: 1.05 tons/m³;

Low average viscosity;

Not condensed at −4⁰ C and not boiled at 100⁰ C;

Eroded in concentrated form and uninfluenced by the environment when diluted;

Insoluble substances percent by weight: ≦5%.

The Example below explain in more detail the preparation of the CSSB additive according to the present invention:

### EXAMPLE 1

To obtain 7 to 10 liters of CSSB additive according to the invention, the following mixture is required:

4.0 to 4.5 liters of polymer solution (trade name: PS);

1.8 to 2.5 liters of alkyl benzene sulfonate solution (trade name: LABs);

0.05 to 0.15 liters of sodium carbonate (Na₂CO₃) or sodium phosphate (Na₂PO₄);

0.1 to 0.15 liters of sulfuric acid (H₂SO₄) or phosphoric acid (H₃PO₄); and

2.0 to 4.0 liters of saltwater or salt-contaminated water.

The accompanying drawing, namely FIG. 1shows the steps in preparing CSSB additive according to the invention.

It begins by mixing 1.0 to 1.5 liters of saltwater or salt-contaminated water with 1.8 to 2.5 liters of alkyl benzene sulfonate solution (trade name: LABs) into a suitable mixer (step 11); then pour into the mixer 4.0 to 4.5 liters of polymer solution (trade name: PS) and stir regularly for several minutes (step 12); next pour into the mixer 0.05 to 0.15 liters of sodium carbonate (Na₂CO₃) or sodium phosphate (Na₂PO₄) and stir regularly for several minutes (step 13). In step 14, pour into the mixer 0.1 to 0.15 liters of sulfuric acid (H₂SO₄) or phosphoric acid (H₃PO₄) and stir regularly again. The CSSB additive according to the present invention is obtained at the end of step 14 by adding the remaining water (saltwater or salt-contaminated water) into the mixer.

The invention also relates to methods for making cement-mortar and cement-concrete by using unsuitable in situ building materials as aggregates which incorporate the CSSB additive according to the invention.

The method in which unsuitable in situ building materials in the invention can be used in making cement-mortar and cement-concrete which incorporate CSSB additive is as follows:

Saline sand, a fine grained, blackish sand, is merged with a small amount of organic mud with γ=1.2−1.4 T/m³. This sand can be found about 50 to 100 meters away from the coast;

Soil containing clay and clay containing stone, such as a red gravel soil with the index of plasticity (Ip)=16.5% or soil-mixed clay and sandy clay;

Saltwater, such as sea-water of pH=7 to 8 or salt contaminated water with the saline degree S=28.2-35 g/liter.

The examples below, namely, Example 2 explains in greater detail the preparation of the unsuitable in situ building materials, such as soil containing clay, clay containing stone, and saline sand as the aggregates. Example 3 explains in greater detail the production of cement mortar and cement concrete by using such aggregates which incorporate CSSB additive.

### EXAMPLE 2

The production of 1 m³ of cement mortar requires a mixture of the following ingredients in the following proportions:

| | |
|---|---|
| Portland cement PCB40 | 359 kg |
| Saline sand | 0.9 m³ |
| Soil containing clay | 0.3 m³ |
| CSSB additive | 0.35 to 0.5 liters |
| Water (seawater or salt- | 200 to 220 liters |
| contaminated water) | |

### EXAMPLE 3

The production of 1 m³ cement concrete requires a mixture of the following ingredients in the following proportions:

| | |
|---|---|
| Portland cement PCB40 | 350 kg |
| Salt-sand | 0.28 m3 |
| Sandy soil | 1.26 m3 |
| CSSB additive | 0.3 to 0.5 liters |
| Water (salt water or salt- | 180 liters |
| contaminated water) | |

The accompanying drawings, namely FIG. 2, show the steps in preparing the unsuitable in situ building materials, such as soil containing clay, clay containing stone, and saline sand as the aggregates for production of cement mortar and cement concrete. FIG. 3shows the steps in making cement mortar and cement concrete which incorporate the CSSB additive according to the invention.

After collecting soil containing clay, clay containing sand, clay containing stone, and salt-sand (step 21), it is necessary to eliminate waste from these materials (step 22), to control the index of plasticity (Ip), the degree of moisture and the degree of salinity (step 23). Finally, these materials have to be ground in order to adhere well with the binder (step 24).

The CSSB additive obtained in step 14 is diluted by saltwater in the desired proportions in a suitable quantity, and the mixture of CSSB additive and saltwater is stirred regularly in order to create foam (step 31). Prepared in situ materials in step 24 are mixed together with Portland cement PC30 or PC40 in the desired proportions in a suitable dispensing system (step 32). The ingredients in step 32 are then mixed with the diluted CSSB additive in step 31 (step 33). Step 33 is preferably carried out in a standard mixer. The concrete mixture is then set in the mold. After 4 weeks, a testing of the sample similar to the testing of standard cement-mortar and cement-concrete, is conducted. Finally, the component formed by the set concrete mixture is removed from the mold (step 35).

Comparative Effects:

(i) The technical norms of cement mortar and cement concrete made from unsuitable in situ building materials, such as soil, soil containing clay, clay containing stone, salt-sand and saltwater which incorporate CSSB additive according to the invention are as follows:

| | |
|---|---|
| Norm of plasticity | 2 to 52% |
| before hardening: | |
| Slum before hardening: | 2 to 4 cm/minute |
| Average coefficient of suck: | 10⁻⁶ cm/s |
| Density: | 1.8 to 1.9 tons/m³ |
| Moisture of in situ materials: | 0 to 70% |
| Compress-resistant intensity | suitable to building |
| (kg/cm²): | requests |
| Hardening time | Begin no earlier than |
| (By the minute): | 30 minutes and end no |
| | later than 120 minutes |
| External view: | soft, smooth, color is |
| | almost identical to |
| | color of the in situ |
| | soil (at low cement |
| | level) and like a |
| | traditional cement |
| | mortar or cement |
| | concrete. |

(ii) By not having to use clean sand (sands cleaned freshwater), clean water (freshwater) or a high-grade cement, the product decreases cost and is beneficial in protecting the environment, specifically:

| | | | Technology by |
|---|---|---|---|
| | | Traditional | using CSSB |
| No. | Norm | technology (USD) | additive (USD) |
| 1 | Cost price of solidification | $3.77 to $7.54 | $3.15 to $5.00 |
| | for 1 m² of irrigational | | |
| | construction, traffic | | |
| | construction | | |
| 2 | Cost price of solidification | $3.15 to $6.30 | $1.89 to $5.00 |
| | for 1 m² of house-foundation | | |

(iii) The construction yields a strong, force-resistant, moisture resistant, and erosion-resistant product.

The product has been used to solidify the beach embankment and wharf in Phuong Nam tourist zone and K1 embanking solidification prevents the sea wave, against erosion of beach in Dong Hoa Hamlet, Long Hoa Commune, Can Gio District, Ho Chi Minh City, Vietnam.

1. An additive (named as CSSB) being a mixture comprising:
10% to 50% (by weight) of polymer solution;
10% to 20% (by weight) of salts of organic acids;
5% to 10% (by weight) of salts of inorganic acids;
2% to 10% (by weight) of catalyst;
10% to 73% (by weight) of saltwater or salt-contaminated water; and
having the following physico-chemical characteristics:
appearance: emulsion;
color: opalescent;
smell: specific pungent smell of acid;
pH ≦3;
material density: 1.05 tons/m³;
low average viscosity;
not condensed at −4⁰ C and not boiled at 100⁰ C;
eroded in concentrated form and uninfluenced to environment when diluted; and
insoluble substances percent by weight: ≦5%.
The polymer styrene (available under the trade name of PS) may be used as the polymer solution;
Alkyl benzene sulphonate solution may be used as the salts of organic acids (available under the trade name of LABS);
Sodium carbonate (Na₂CO₃) or sodium phosphate (Na₂PO₄) may be used as the salts of inorganic acids, for example;
Sulfuric acid (H₂SO₄) or phosphoric acid (H₃PO₄) may be used as the catalyst.

2. A method for preparing CSSB additive comprising:
a) pouring salts of organic acids into saltwater, and stirring regularly;
b) pouring polymer solution into the mixture of saltwater together with salts of organic acids, and stirring regularly;
c) pouring salts of inorganic acids into the above mixture of saltwater and salts of organic acids together with polymer solution, and stirring regularly;
d) adding the remaining water into the above mixture of saltwater and salts of organic acids and polymer solution and together with salts of inorganic acids, and stirring regularly;
e) adding more water into the mixture, if the obtained additive is too concentrated.

3. A method for preparation of unsuitable in situ building materials, the methods comprising:
a) collecting unsuitable in situ building materials, such as soil containing clay, sand containing clay, clay containing stone, salt-sand;
b) eliminating waste from unsuitable in situ building materials;
c) controlling the index of plasticity (Ip), the degree of moisture and the degree of salinity of unsuitable in situ building materials;
d) grinding unsuitable in situ building materials.

4. A method for making cement mortar and cement concrete, the method comprising:
a) diluting CSSB additive prepared by a process comprising the steps of pouring salts of organic acids into saltwater;
pouring a polymer solution into the mixture of saltwater together with salts of organic acids;
pouring salts of inorganic acids into the above mixture of saltwater and salts of organic acids together with the polymer solution;
adding the remaining water into the above mixture of saltwater and salts of organic acids and polymer solution and together with salts of inorganic acids;
adding more water into the mixture, if the obtained additive is too concentrated;
b) providing unsuitable in situ building materials prepared by a process comprising the steps of collecting unsuitable in situ building materials, such as soil containing clay, clay containing sand, clay containing stone, salt-sand;
eliminating waste from unsuitable in situ building materials;
controlling the index of plasticity (Ip), the degree of moisture and the degree salinity of unsuitable in situ building materials;
grinding unsuitable in situ building materials;
c) mixing in situ materials together with Portland cement PC30 or PC40;
d) providing ingredients prepared through a process of mixing in situ materials together with Portland cement PC30, PC40, and mixing the ingredients together with the diluted CSSB additive; mixing the resulting concrete mix with additional water;
e) allowing the concrete mixture to set in the mold, and testing the sample just as normal cement-mortar and cement-concrete.

5. A concrete mix comprising:
(a) Portland cement PCB0 in a proportion of 14%;
(b) salt sand in a proportion of 58%;
(c) clay in a proportion of 18%;
(d) CSSB additive in a proportion of 0.02%; and,
(e) salt-water or salt-contaminated water in a proportion of 9.98%.

6. A concrete mix comprising:
(a) Portland cement PCB0 in a proportion of 13%;
(b) Stone 0-4 cm (merged sand/soil) in a proportion of 58%
(c) Salt-sand in a proportion of 14%;
(d) CSSB additive in a proportion of 0.02%; and,
(e) salt-water or salt-contaminated water in a proportion of 6.98%.
